(19) United States
(12) Patent Application Publication
(10) Pub. No.: US 2007/0206284 A1
(43) Pub. Date: Sep. 6, 2007

(54) ROAD SALIENT REFLECTOR NAIL

(76) Inventor: Hungchen LEE, Taipei (TW)

Correspondence Address: BANGER SHIA, 204 CANYON CREEK, VICTORIA, TX, 77901-3695, US

(21) Appl. No.: 11/307,975

(22) Filed: Mar. 1, 2006

(51) Int. Cl. G02B 5/12

(52) U.S. Cl. 359/515

(57) ABSTRACT

The present invention provides a salient reflector nail typically comprising of a main body, reflector straps and an abutment sleeve; said reflector straps are separately bonded on the main body, said main body extends out a flange surround the bottom rim outwardly, said abutment sleeve extends out flange from top inner edge inwardly, by welting the flange of the abutment sleeve over the flange of the main body, and filling out elastic filler into the inside of the abutment sleeve, said main body is retained on the top side of the abutment sleeve. The side wall of said abutment sleeve is in slant so that the whole sleeve appears into small head and big bottom. The elastic reflector nail can efficiently avoid rigidly stroke between the wheels of vehicles and the main body, and the reflector straps falling off from the main body, and the main body breaking down, meanwhile guarantee the alert effect, and prolong the service life of the reflector nail.

### BACKGROUND OF THE INVENTION

1. Field of the Invention

The present invention relates to a road signal accessory, and more particularly to a retaining structure of salient reflector nail.

2. Description of Prior Art

In accordance with a conventional technology, as shown in FIG. 1, a road salient reflector nail is typically comprised of a plastic main body 1′ and reflector straps 2′, said reflector strap 2′ is retained on the main body 1′, and said main body 1′ is bonded on the ground by epoxy 3′ or other glues.

As using said reflector nail, due to the high rigidness and poor elasticity of said main body 1′, when the vehicles roll out, said main body 1′ is stroked by the wheels of the vehicles, with the result that the reflector straps 2′ is easy to fall off from the main body 1′ to lose alert effect, therefore the service life of said reflector nail is short. Additionally, depending on a thin epoxy bond line 3′, the reflector nail can not get enough adhesive force to grab ground, and can not stand on after a certain use term so as to loose off departing the ground, further to affect normal use and altering effect.

### OBJECTS AND SUMMARY OF THE INVENTION

It is therefore a main object of the present invention to provide a salient reflector nail with high elasticity to avoid the reflector straps falling off under vehicles rolling out, and longer service life.

It is a next object of the present invention to provide a salient reflector nail with high adhesive force, stable mounting, and low production cost, so as to guarantee to use in normal and alert effect.

For archiving said goals, the present invention provides a salient reflector nail typically comprising of a main body, reflector straps and an abutment sleeve; said reflector straps are separately bonded on the main body, said main body extends out a flange surround the bottom rim outwardly, said abutment sleeve extends out flange from top inner edge inwardly, by welting the flange of the abutment sleeve over the flange of the main body, and filling out elastic filler into the inside of the abutment sleeve, said main body is retained on the top side of the abutment sleeve.

The side wall of said abutment sleeve is in slant so that the whole sleeve appears into small head and big bottom.

Said elastic filler can be plastic, nylon or rubber.

Utilizing above-mentioned structure, as mounting the present invention on the road, drill in pit coordinating to the size of the abutment sleeve, by coating epoxy adhesive or other glues over the out side surface of the abutment sleeve, the assembled abutment sleeve is retained into the pit so as to locate the reflector nail in site.

In this case, the present invention offers elastic filler under the main body so as to make the whole reflector nail more elastic, therefore as vehicles roll out, taking the advantages of buffer action of the elastic filler, it can efficiently avoid rigidly stroke between the wheels of vehicles and the main body, and the reflector straps falling off from the main body, and the main body breaking down, meanwhile guarantee the alert effect, and prolong the service life of the reflector nail.

And the outward slant side wall of the abutment sleeve such as reverse conical structure can make the reflector nail more adhesive force, mount more stably, so as to avoid the reflector nail loosing off and falling off the ground, and guarantee the reflector nail use in normal, really bring the alert effect into action.

### BRIEF DESCRIPTION OF THE DRAWINGS

FIG. 1 is a scheme of the prior art.

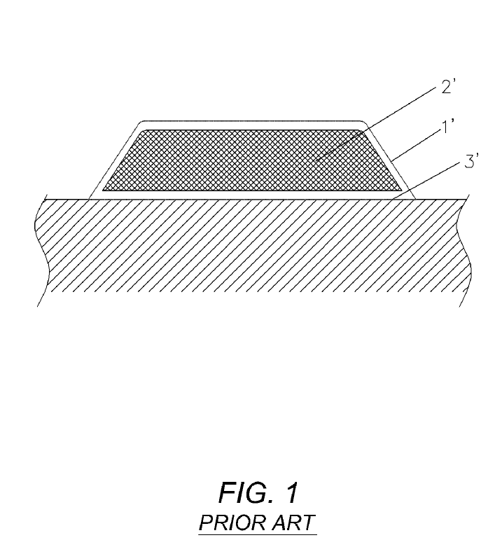

FIG. 2 is a scheme showing the first embodiment of the present invention.

FIG. 3 is a scheme showing the second embodiment of the present invention.

### DETAILED DESCRIPTION OF PREFERRED EMBODIMENTS

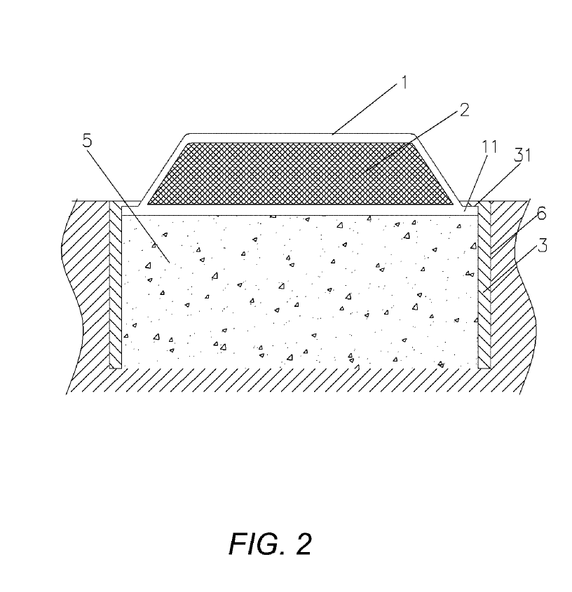

Referring to FIG. 2, a salient reflector nail provided of the present invention is typically consisted of a main body 1, reflector straps 2 and an abutment sleeve 3.

Said reflector straps 2 are respectively retained on the shell 1, as same as the conventional technology, so it will not be described in detail.

Said main body 1 extends out a flange 11 from the bottom rim outwardly.

Said abutment sleeve 3 extends out flange 31 from top inner edge inwardly, by welting the flange 31 of the abutment sleeve 3 over the flange 11 of the main body 1, and filling out elastic filler into the inside of the abutment sleeve 3, said main body 1 is retained on the top side of the abutment sleeve 3. Said elastic filler 6 can be plastic, nylon or rubber.

As mounting the present invention on the road, drill in pit coordinating to the size of the abutment sleeve 3, by coating epoxy adhesive 7 or other glues over the out side surface of the abutment sleeve 3, the assembled abutment sleeve 3 is retained into the pit so as to locate the reflector nail in site. In this case, the present invention offers elastic filler 6 under the main body 1 so as to make the whole reflector nail more elastic, therefore as vehicles roll out, taking the advantages of buffer action of the elastic filler, it can efficiently avoid rigidly stroke between the wheels of vehicles and the main body 1, and the reflector straps 2 falling off from the main body 1, and the main body 1 breaking down, meanwhile guarantee the alert effect, and prolong the service life of the reflector nail.

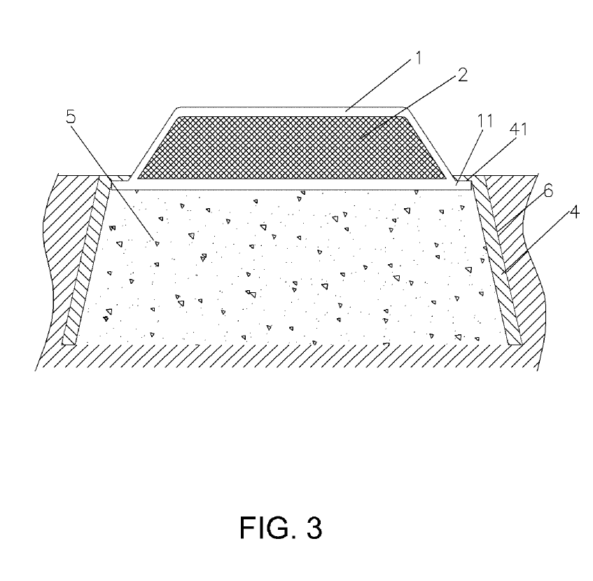

FIG. 3 is showing another embodiment of the present invention; comparing to FIG. 2, the difference is that the side wall of the abutment sleeve 3 appears into slant, so that the whole abutment sleeve 3 is shaped into reverse conical sleeve with small top and big bottom. In construction, the outward slant side wall of the abutment sleeve such as reverse conical structure can make the reflector nail more adhesive force, mount more stably, so as to avoid the reflector nail loosing off and falling off the ground, and guarantee the reflector nail use in normal, really bring the alert effect into action.

What is claimed is:

1. A salient reflector nail typically comprising of a main body, reflector straps and an abutment sleeve; said reflector straps are separately bonded on the main body, said main body extends out a flange surround the bottom rim outwardly, said abutment sleeve extends out flange from top inner edge inwardly, by welting the flange of the abutment sleeve over the flange of the main body, and filling out elastic filler into the inside of the abutment sleeve, said main body is retained on the top side of the abutment sleeve.

2. A salient reflector nail as claimed in claim 1, wherein the side wall of said abutment sleeve is in slant so that the whole sleeve appears into small head and big bottom.

3. A road salient reflector nail as claimed in claim 1, wherein said elastic filler can be plastic.

4. A road salient reflector nail as claimed in claim 1, wherein said elastic filler can be nylon.

5. A road salient reflector nail as claimed in claim 1, wherein said elastic filler can be rubber.
